(19) United States
(12) Patent Application Publication
(10) Pub. No.: US 2026/0245922 A1
(43) Pub. Date: Aug. 20, 2026

(54) Method of Producing Membrane Electrode Assembly

(71) Applicant: HONDA MOTOR CO., LTD., TOKYO (JP)

(72) Inventors: Kento KUSATSUGU, WAKO-SHI (JP); Yohei KATAOKA, WAKO-SHI (JP); Shinsuke CHOKYU, WAKO-SHI (JP); Wataru KASHI, WAKO-SHI (JP); Takayuki SAITO, WAKO-SHI (JP)

(21) Appl. No.: 19/542,874

(22) Filed: Feb. 18, 2026

(30) Foreign Application Priority Data
Feb. 19, 2025 (JP) 2025-024748

(51) Int. Cl. H01M 8/0297

(52) U.S. Cl. CPC H01M 8/0297

(57) ABSTRACT

A method of producing a membrane electrode assembly, including: a swelling step of swelling an ion exchange membrane with a solvent; a stacking step of stacking an electrode on the ion exchange membrane; a compressing step of applying, to the ion exchange membrane and the electrode, a compressive load capable of suppressing shrinkage of the ion exchange membrane in a plane direction; a bonding step of heating and bonding the ion exchange membrane and the electrode while maintaining the compressive load; and a cooling step of cooling the ion exchange membrane and the electrode while maintaining the compressive load.

### CROSS-REFERENCE TO RELATED APPLICATIONS

This application is based upon and claims the benefit of priority from Japanese Patent Application No. 2025-024748 filed on February 19, 2025, the contents of which are incorporated herein by reference.

### BACKGROUND OF THE INVENTION

### FIELD OF THE INVENTION

The present disclosure relates to a method of producing a membrane electrode assembly.

### DESCRIPTION OF THE RELATED ART

In a water electrolysis device, a water electrolysis cell in which electrodes are disposed on both sides of an ion exchange membrane made of a polymer electrolyte is used. In order to obtain a water electrolysis cell increased in size, a membrane electrode assembly (MEA) in which the ion exchange membrane and the electrodes are joined is desired. In the field of fuel cells, thermocompression bonding of an electrolyte membrane and electrodes is known as a method for producing a membrane electrode assembly (for example, JP 2009-283241 A).

### SUMMARY OF THE INVENTION

In the case of a water electrolysis device, the membrane electrode assembly is used under a condition in which the ion exchange membrane contains a certain amount of water, and thus the membrane electrode assembly is easily affected by a dimensional change of the ion exchange membrane. Therefore, in the production of the membrane electrode assembly for a water electrolysis device, it is desired to join the electrodes to the ion exchange membrane in a state of being swollen by water contained therein.

However, it has been found that in the conventional thermocompression bonding (JP 2009-283241 A), the dimensional change of the ion exchange membrane in the process of thermocompression bonding is so large that the electrodes cannot be bonded to the swollen ion exchange membrane.

The present disclosure has the object of solving the aforementioned problem.

An aspect of the present disclosure is characterized by a method of producing a membrane electrode assembly, including: a swelling step of swelling an ion exchange membrane with a solvent; a stacking step of stacking an electrode on the ion exchange membrane; a compressing step of applying, to the ion exchange membrane and the electrode, a compressive load capable of suppressing shrinkage of the ion exchange membrane in a plane direction; a bonding step of heating and bonding the ion exchange membrane and the electrode while maintaining the compressive load; and a cooling step of cooling the ion exchange membrane and the electrode to a temperature at which the ion exchange membrane remains dimensionally stable while maintaining the compressive load.

The method of producing a membrane electrode assembly of the present disclosure can suitably bond an electrode to an ion exchange membrane having a large dimensional change in thermocompression bonding.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a cross-sectional view of a membrane electrode assembly according to an embodiment;

FIG. 2 is a flowchart showing steps of a method of producing the membrane electrode assembly according to the embodiment;

FIG. 3 is an explanatory diagram showing a configuration of a jig used for compressing an electrolyte membrane and an electrode;

FIG. 4 is an explanatory view of the jig applying a compressive load;

FIG. 5 is a table showing joining conditions and evaluation results of joined states of Experimental Examples 1 to 4; and

FIG. 6 is an explanatory view of a method of producing a membrane electrode assembly according to a modified embodiment.

### DETAILED DESCRIPTION OF THE INVENTION

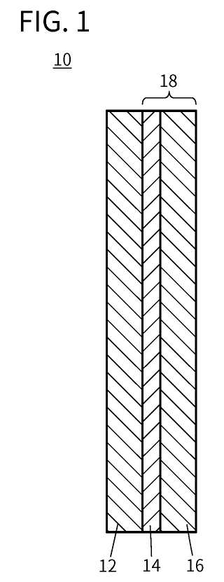

A membrane electrode assembly (hereinafter, MEA 10) according to the present embodiment shown in FIG. 1 is used for, for example, an anion exchange membrane (AEM) water electrolysis cell using an anion exchange membrane (AEM). The MEA 10 has a structure in which an anode catalyst layer 14 and an anode porous transport layer (anode PTL 16) are stacked on an ion exchange membrane 12.

The ion exchange membrane 12 is, for example, the AEM having conductivity for anions such as OH⁻ ions. The ion exchange membrane 12 swells when coming into contact with water as a solvent, and the volume thereof increases. Since the ion exchange membrane 12 of the present embodiment is bonded to the electrode 18 in a swollen state, the dimension in the plane direction hardly changes due to swelling caused by water absorption. The dimension of the ion exchange membrane 12 increases mainly in the thickness direction depending on the water content. The ion exchange membrane 12 is formed in a rectangular shape, for example. The ion exchange membrane 12 is not limited to an anion exchange membrane, and may be a proton exchange membrane (PEM) having proton conductivity.

The anode catalyst layer 14 contains, for example, a nickel-based alloy catalyst. The anode catalyst layer 14 may contain an ionomer (a polymer having ion exchange properties) for bonding with the ion exchange membrane 12. The anode PTL 16 is formed of a conductive sheet made of metallic fibers or the like. The anode PTL 16 may be a metallic foam, a metallic monolith, a metallic mesh. As the metal material, austenitic stainless steel, nickel-based alloys such as Hastelloy or Inconel, and the like can be used. The anode catalyst layer 14 and the anode PTL 16 are integrated to form an anode 18. The anode catalyst layer 14 and the anode PTL 16 are provided as an integrated sheet material of an anode porous transport electrode (anode PTE). As described later, the MEA 10 of the present embodiment is produced by thermocompression bonding the anode PTE, which is the electrode 18, to the ion exchange membrane 12. The electrode 18 is formed in a rectangular shape having substantially the same dimensions as the ion exchange membrane 12.

In assembling the water electrolysis cell, an electrode on the cathode side is formed by bringing metallic mesh or the like with a catalyst formed on its surface into contact with the MEA 10 having the above-described structure.

In the MEA 10, a cathode porous transport electrode (electrode 18) may be provided on the cathode side of the ion exchange membrane 12. In this case, a PTE including a cathode catalyst layer and the cathode porous diffusion layer is stacked on the ion exchange membrane 12. The cathode PTE can be bonded to the ion exchange membrane 12 by being stacked on the ion exchange membrane 12 simultaneously with the anode PTE in a stacking step S20 to be described later.

Hereinafter, a method of producing the MEA 10 will be described.

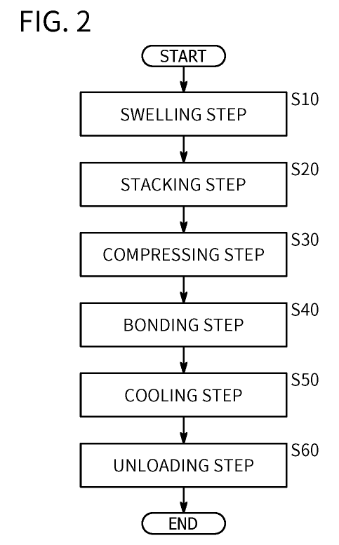

As shown in FIG. 2, the method of producing the MEA 10 of the present embodiment starts with a swelling step S10. In the swelling step S10, the ion exchange membrane 12 is swelled with the solvent. In the present embodiment, the solvent is water. In the swelling step S10, the ion exchange membrane 12 absorbs water and swells.

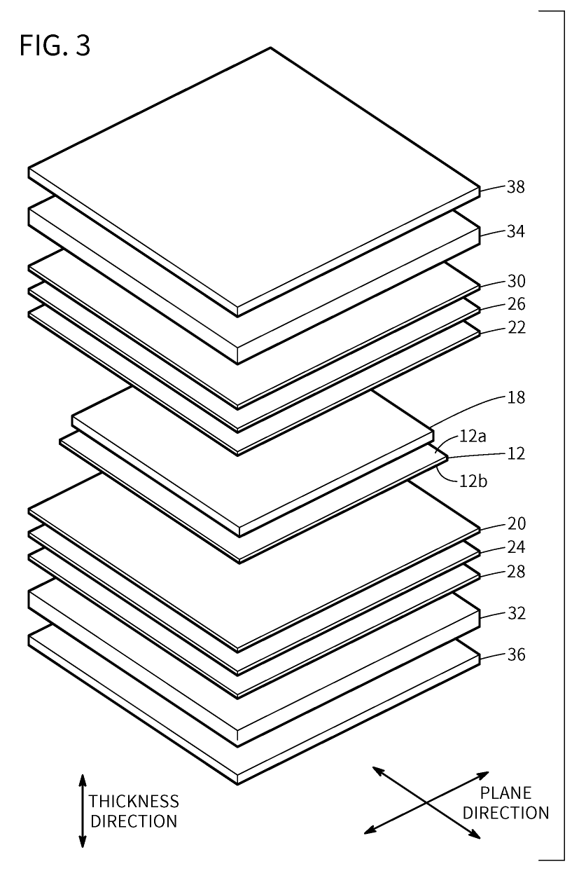

Next, the method of producing the MEA 10 proceeds to the stacking step S20. In the stacking step S20, as shown in FIG. 3, the anode PTE as the electrode 18 is stacked on a first surface 12a of the swollen ion exchange membrane 12. Further, a first flexible sheet 20, a second flexible sheet 22, a first porous paper 24, a second porous paper 26, a first release sheet 28, a second release sheet 30, a first die 32, a second die 34, a first sponge sheet 36, and a second sponge sheet 38 are stacked.

The first flexible sheet 20 abuts on the cathode-side second surface 12b of the ion exchange membrane 12. As the first flexible sheet 20, a resin sheet that is impermeable to water and has heat resistance and appropriate flexibility is used. For example, Teflon (registered trademark) or the like is preferably used as the first flexible sheet 20. The first flexible sheet 20 has a plane dimension larger than those of the ion exchange membrane 12 and the electrode 18.

The second flexible sheet 22 is disposed so as to face the first flexible sheet 20 and abuts on the surface of the electrode 18 (anode PTE). The second flexible sheet 22 is formed of the same material and in the same dimensions as the first flexible sheet 20.

The ion exchange membrane 12 and the electrode 18 are sandwiched between the first flexible sheet 20 and the second flexible sheet 22. The first flexible sheet 20 and the second flexible sheet 22 apply a compressive load, which will be described later, to the ion exchange membrane 12 and the electrode 18, and prevent the ion exchange membrane 12 from shrinking due to thermocompression bonding. The first flexible sheet 20 and the second flexible sheet 22 are in close contact with each other at a portion surrounding the outer peripheral portions of the ion exchange membrane 12 and the electrode 18 in the plane direction, and suppress outflow of water from the ion exchange membrane 12.

The first porous paper 24 is disposed under the first flexible sheet 20 and the second porous paper 26 is disposed over the second flexible sheet 22. The first porous paper 24 and the second porous paper 26 are low-density porous papers, and are commercially available as, for example, Whartrite (registered trademark). The first porous paper 24 and the second porous paper 26 are deformed to follow the unevenness of the ion exchange membrane 12 and the electrode 18 due to the compressive load applied. As a result, the compressive load is applied to the ion exchange membrane 12 and the electrode 18 with a substantially uniform pressure distribution in the in-plane direction.

The first release sheet 28 is disposed under the first porous paper 24 and the second release sheet 30 is disposed over the second porous paper 26. The first release sheet 28 and the second release sheet 30 are, for example, polyimide sheets. The first release sheet 28 prevents the first die 32 and the first porous paper 24 from sticking to each other, and the second release sheet 30 prevents the second die 34 and the second porous paper 26 from sticking to each other.

The first die 32 is disposed below the first release sheet 28, and the second die 34 is disposed above the second release sheet 30. The first die 32 and the second die 34 are formed in a flat plate shape, and transmit the compressive load to the ion exchange membrane 12 and the electrode 18. The first die 32 and the second die 34 are formed of, for example, stainless steel plates.

The first sponge sheet 36 is disposed below the first die 32, and the second sponge sheet 38 is disposed above the second die 34. The first sponge sheet 36 and the second sponge sheet 38 are formed of, for example, a silicone sponge sheet. The first sponge sheet 36 and the second sponge sheet 38 are disposed between the first and second dies 32, 34 and a pressing device, and transmit the load of the pressing device to the first and second dies 32, 34.

Next, as shown in FIG. 2, the method of producing the MEA 10 proceeds to a compressing step S30. In the compressing step S30, the stack shown in FIG. 3 is carried into the pressing device, and the compressive load is applied to the ion exchange membrane 12 and the electrode 18 in the thickness direction by the pressing device. In the present embodiment, a compressive load of a degree that can prevent the ion exchange membrane 12 from shrinking is applied to the ion exchange membrane 12 and the electrode 18. The compressive load is applied at the degree, for example, which causes a surface pressure that is larger than 1.5 MPa, and more preferably about 3 MPa.

Next, the method of producing the MEA 10 proceeds to a bonding step S40. In the bonding step S40, the ion exchange membrane 12 and the electrode 18 are heated to a temperature at which at least a portion of the ion exchange membrane 12 or the ionomer softens while the compressive load is maintained. As a non-limiting example, the bonding step S40 is performed while the temperature is maintained at 150 °C for about 5 to 10 minutes. The heating temperature and the bonding time are appropriately adjusted according to the glass transition point of the ion exchange membrane 12 and the ionomer used for bonding. The ion exchange membrane 12 and the electrode 18 is bonded in the bonding step S40. The heating of the ion exchange membrane 12 and the electrode 18 is performed by high-frequency induction heating or the like described in JP. 2018-006195 A, for example.

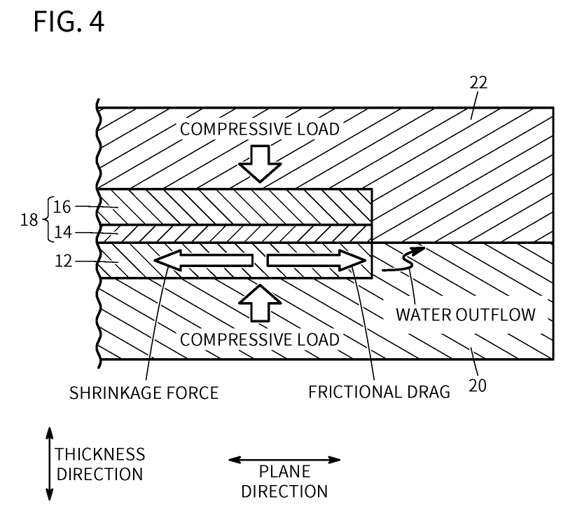

As shown in FIG. 4, water contained in the ion exchange membrane 12 is partially vaporized by heating, and flows out through the gap between the first flexible sheet 20 and the second flexible sheet 22. Therefore, the volume of the ion exchange membrane 12 decreases as the water flows out. In the present embodiment, since the compressive load is applied in the bonding step S40, a frictional drag is generated in the ion exchange membrane 12 against a shrinkage force of the ion exchange membrane 12. As a result, the shrinkage force in the plane direction of the ion exchange membrane 12 is suppressed, and the ion exchange membrane 12 shrinks in the thickness direction. Due to the suppression of deformation of the ion exchange membrane 12 in the plane direction, the ion exchange membrane 12 and the electrode 18 are favorably bonded.

Next, as shown in FIG. 2, the method of producing the MEA 10 proceeds to a cooling step S50. In the cooling step S50, while the compressive load is maintained, the ion exchange membrane 12 and the electrode 18 are cooled to a temperature at which deformation of the ion exchange membrane 12 is suppressed. In the cooling step S50, if the compressive load becomes unapplied before the temperature is sufficiently lowered, the ion exchange membrane 12 is deformed in the plane direction, and the electrode 18 is peeled off from the ion exchange membrane 12. Therefore, it is necessary to maintain the compressive load even in the cooling step S50. In the cooling step S50, it is preferable to cool the ion exchange membrane 12 and the electrode 18 and maintain the compressive load until the temperature of the ion exchange membrane 12 and the electrodes 18 becomes 50 °C or less.

Next, the method of producing the MEA 10 proceeds to the unloading step S60. The unloading step S60 is a step of removing the compressive load from the ion exchange membrane 12 and the electrode 18. In the unloading step S60, the MEA 10 in which the electrode 18 is bonded to the ion exchange membrane 12 is taken out from between the first flexible sheet 20 and the second flexible sheet 22. Thereafter, the MEA 10 is shaped as necessary, and the MEA 10 of the present embodiment is completed.

Hereinafter, Experimental Examples 1 to 4 will be described.

### Experimental Example 1

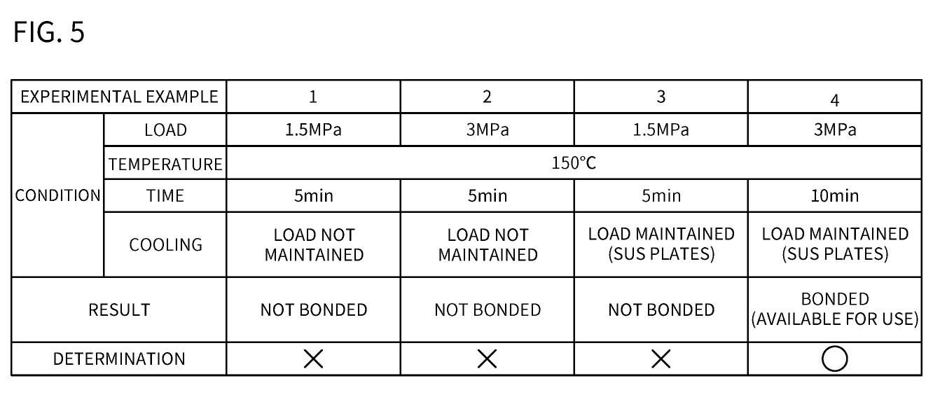

As Experimental Examples 1 to 4 shown in FIG. 5, experiments were performed in which an anode PTE obtained by applying an iron-nickel catalyst and an ionomer to the surface of a porous body of Hastelloy was bonded as the electrode 18 to the ion exchange membrane 12 (anion exchange membrane).

In Experimental Example 1, in the compressing step S30, a compressive load that generates the pressure of 1.5 MPa was applied to the ion exchange membrane 12 and the electrode 18. In addition, heating was performed at the temperature of 150 °C for 5 minutes in the bonding step S40. In this experimental example, the compressive load was removed at the same time as the completion of the bonding step S40.

Thereafter, the bonding state between the cooled ion exchange membrane 12 and the electrode 18 that had been cooled was evaluated. In Experimental Example 1, when the first flexible sheet 20 was peeled off, the ion exchange membrane 12 was easily peeled off from the electrode 18, and the ion exchange membrane 12 could not remain bonded to the electrode 18. From this result, it was presumed that the compressive load was not enough to keep the ion exchange membrane 12 from shrinking.

### Experimental Example 2

In Experimental Example 2, a larger compressive load was applied in view of the result of Experimental Example 1. In Experimental Example 2, a compressive load that causes the surface pressure of 3 MPa was applied in the compressing step S30. In Experimental Example 2, heating was performed at the temperature of 150 °C for 5 minutes in the bonding step S40. In Experimental Example 2, the compressive load was removed at the same time as the completion of the bonding step S40.

Thereafter, the bonding state between the ion exchange membrane 12 and the electrode 18 that had been cooled was evaluated. Also in Experimental Example 2, when the first flexible sheet 20 was peeled off, the ion exchange membrane 12 was easily peeled off from the electrode 18, and the ion exchange membrane 12 could not remain bonded to the electrode 18. In Experimental Example 2, it was confirmed from the results of visual observation that the ion exchange membrane 12 did not shrink under the condition of applying the load in the bonding step S40. From the results of Experimental Example 2, it was found that, the ion exchange membrane 12 was shrunk in the cooling step S50 as the compressive load was removed in the state where heat remained, and the electrode 18 was peeled off.

### Experimental Example 3

In Experimental Example 3, in view of the results of Experimental Example 2, a method was attempted in which the compressive load was maintained even in the cooling step S50, and the unloading step S60 was performed after the temperature became sufficiently low. In Experimental Example 3, in the compressing step S30, a compressive load that causes the surface pressure of 1.5 MPa was applied. In the bonding step S40, the heating was performed at the temperature of 150 °C for 5 minutes. In the cooling step S50, the compressive load was maintained until the temperature was lowered to 50 °C or less.

Thereafter, the bonding state between the ion exchange membrane 12 and the electrode 18 was evaluated. Also in Experimental Example 3, when the first flexible sheet 20 was peeled off, the ion exchange membrane 12 was easily peeled off from the electrode 18, and the ion exchange membrane 12 could not remain bonded to the electrode 18. From this result, it was presumed that, in Experimental Example 3, the compressive load was not enough to keep the ion exchange membrane 12 from shrinking.

### Experimental Example 4

In Experimental Example 4, in view of the results of Experimental Example 3, the compressing step S30 was changed to apply a compressive load that causes the surface pressure of 3 MPa. The bonding step S40 was performed at the temperature of 150 °C. Further, in the bonding step S40, the temperature was maintained at 150 °C for 10 minutes in order to reliably heat the interface between the ion exchange membrane 12 and the electrode 18. In the cooling step S50, the compressive load was maintained until the temperature was lowered to 50 °C or less. Thereafter, the ion exchange membrane 12 and the electrode 18 were taken out after performing the unloading step S60, and the joint state between the ion exchange membrane 12 and the electrodes 18 was evaluated.

According to Experimental Example 4, the ion exchange membrane 12 and the electrode 18 were not peeled off from each other and could remain integrated as the MEA 10. From the results of Experimental Examples 1 to 4, it was found that a sufficient compressive load and the maintenance of the compressive load until the cooling step S50 are necessary for bonding the electrode 18 to the ion exchange membrane 12 in a swollen state.

### Modification of Embodiment

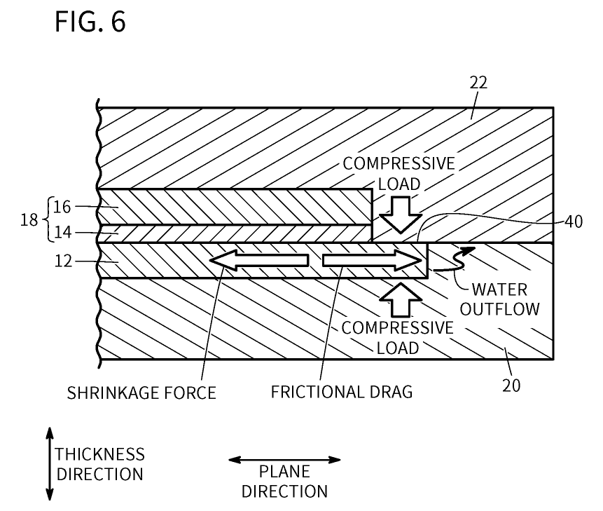

As shown in FIG. 6, in the method of producing a membrane electrode assembly according to the present modification, the planar size of the ion exchange membrane 12 used for producing the MEA 10 is made larger than the planar size of the electrode 18. The ion exchange membrane 12 has an extension part 40 extending outward in a plane direction from the peripheral edge part of the electrode 18.

As shown in the drawing, in the stacking step S20 and the compressing step S30, the extension part 40 is sandwiched and held between the first flexible sheet 20 and the second flexible sheet 22 in the thickness direction at the peripheral edge part of the electrode 18. As shown in the drawing, the ion exchange membrane 12 is restricted from shrinking in the plane direction by the peripheral edge portion thereof being held by the first flexible sheet 20 and the second flexible sheet 22. Thus, according to the present modification, the shrinkage of the ion exchange membrane 12 can be more effectively suppressed, the electrodes 18 can be bonded to the swollen ion exchange membrane 12, and the MEA 10 can be produced.

The following supplementary notes are further disclosed in relation to the above embodiment.

### Supplementary Note 1

The method of producing the membrane electrode assembly of the present disclosure, includes: the swelling step (S10) of swelling the ion exchange membrane with the solvent; the stacking step (S20) of stacking the electrode on the ion exchange membrane; the compressing step (S30) of applying, to the ion exchange membrane and the electrode, the compressive load capable of suppressing shrinkage of the ion exchange membrane in the plane direction; the bonding step (S40) of heating and bonding the ion exchange membrane and the electrode while maintaining the compressive load; and the cooling step (S50) of cooling the ion exchange membrane and the electrode to the temperature at which the ion exchange membrane remains dimensionally stable while maintaining the compressive load.

According to the method of producing the membrane electrode assembly, it is possible to suppress shrinkage of the swollen ion exchange membrane in the plane direction in the bonding step, and it is possible to produce the membrane electrode assembly in which the electrode is bonded to the swollen ion exchange membrane.

### Supplementary Note 2

In the method of producing the membrane electrode assembly according to Supplementary Note 1, the cooling step may include maintaining the compressive load at least to the temperature of 50 °C or less. The method of producing the membrane electrode assembly suppresses peeling between the ion exchange membrane and the electrode, and enables the electrode to be bonded to the swollen ion exchange membrane.

### Supplementary Note 3

In the method of producing the membrane electrode assembly according to Supplementary Note 1 or 2, in the compressing step, the compressive load may be applied via the first flexible sheet (20) that abuts on the ion exchange membrane and the second flexible sheet (22) that abuts on the electrode. The method of producing the membrane electrode assembly enables production of the membrane electrode assembly by suppressing shrinkage of the ion exchange membrane.

### Supplementary Note 4

In the method of producing the membrane electrode assembly according to Supplementary Note 3, the ion exchange membrane may have the extension part (40) extending outward from the electrode, and the first flexible sheet and the second flexible sheet may sandwich and hold the extension part from a thickness direction of the ion exchange membrane. The method of producing the membrane electrode assembly enables production of the membrane electrode assembly by suppressing shrinkage of the ion exchange membrane.

### Supplementary Note 5

In the method of producing the membrane electrode assembly according to Supplementary Note 1, the compressing step may include applying the compressive load that generates a pressure equal to or higher than 3 MPa to the ion-exchange membrane and the electrode. The method of producing the membrane electrode assembly enables production of a membrane electrode assembly by suppressing shrinkage of the ion exchange membrane.

Although concerning the present disclosure, a detailed description thereof has been presented above, the present disclosure is not necessarily limited to the individual embodiments described above. These embodiments can be subjected to various additions, substitutions, modifications, partial deletions and the like, within a range that does not depart from the essence and gist of the present disclosure, or alternatively, the spirit and gist of the present disclosure as derived from the contents described in the claims and their equivalents. Further, the embodiments can also be implemented together in combination. For example, in the above-described embodiments, the order of each of the operations and the order of each of the processes are illustrated as examples, and the present invention is not necessarily limited to these features. The same applies also in the case that numerical values or mathematical expressions are used in the description of the aforementioned embodiments.

1. A method of producing a membrane electrode assembly, comprising:
a swelling step of swelling an ion exchange membrane with a solvent;
a stacking step of stacking an electrode on the ion exchange membrane;
a compressing step of applying, to the ion exchange membrane and the electrode, a compressive load capable of suppressing shrinkage of the ion exchange membrane in a plane direction;
a bonding step of heating and bonding the ion exchange membrane and the electrode while maintaining the compressive load; and
a cooling step of cooling the ion exchange membrane and the electrode to a temperature at which the ion exchange membrane remains dimensionally stable while maintaining the compressive load.

2. The method of producing the membrane electrode assembly according to claim 1, wherein
the cooling step includes maintaining the compressive load at least to a temperature of 50 °C or less.

3. The method of producing the membrane electrode assembly according to claim 1, wherein
in the compressing step, the compressive load is applied via a first flexible sheet that abuts on the ion exchange membrane and a second flexible sheet that abuts on the electrode.

4. The method of producing the membrane electrode assembly according to claim 3, wherein
the ion exchange membrane may have an extension part extending outward from the electrode, and
the first flexible sheet and the second flexible sheet may sandwich and hold the extension part from a thickness direction of the ion exchange membrane.

5. The method of producing the membrane electrode assembly according to claim 1, wherein the compressing step includes applying the compressive load that generates a pressure equal to or higher than 3 MPa to the ion-exchange membrane and the electrode.
